(19) United States
(12) Patent Application Publication
(10) Pub. No.: US 2012/0210374 A1
(43) Pub. Date: Aug. 16, 2012

(54) Video-On-Demand (VOD)-Augmented eBook

(76) Inventors: Charles Dasher, Lawrenceville, GA (US); Bob Forsman, Sugar Hill, GA (US); Chris Phillips, Hartwell, GA (US)

(21) Appl. No.: 13/026,799

(22) Filed: Feb. 14, 2011

(51) Int. Cl. H04N 7/173

(52) U.S. Cl. 725/93

(57) ABSTRACT

A system and method for providing an environmentally enhanced experience to a user reading an electronic book (eBook) on an eBook reader in proximity to a television. An application program in the eBook reader causes the eBook reader to send an indication to a Video On Demand (VOD) television delivery system identifying a page of the eBook displayed on the eBook reader. The VOD television delivery system accesses an eVODBook package that defines start, stop_{;} and loop locations in video content associated with the eBook. Video content associated with text or an illustration on the eBook page currently displayed on the eBook reader is streamed to a Set Top Box (STB) and the television in accordance with the eVODBook package.

### BACKGROUND

The present invention relates to television delivery systems. More particularly, and not by way of limitation, the present invention is directed to an integrated system and method enabling a television delivery system to deliver on demand, audio and/or video streams related to text on a displayed page of an electronic book (eBook) reader.

Video On Demand (VOD) systems allow users to purchase and consume multimedia content within their own Multiple System Operator (MSO)/cable system. This content is played out through a Set Top Box (STB) and television (TV) within the user's premises.

Within the realm of computing devices, a number of devices such as the iPad™ the Kindle™, the Nook™, smart phones, and other mobile devices are capable of operating as eBook readers. These eBook readers include interactive applications that enable the users to control the readers to display desired pages or illustrations from the eBooks being read.

### SUMMARY

Current eBook readers, although providing a degree of interactivity, are limited in the types of sensory information they can provide to the user. They enable a user to “turn” pages or jump from a currently displayed page to any other page in the book. In this respect, the reading experience is generally limited to what a reader would experience with a paper book. When an eBook reader is also connected to the Internet, it may enable the user to click on an embedded link to obtain further information about a subject being discussed in the book. While this increases the amount of information available to the user, it is very disruptive to the reading experience.

The present invention creates an interactive eBook experience in which an eBook reader is augmented with audio and/or video information delivered by a VOD system to the user's television and media speakers. Actions such as turning a page on the eBook reader trigger a VOD server (pump) to stream to the user's STB, various multimedia assets, which are then viewed and heard on the user's television and speakers.

In one embodiment, the present invention is directed to a system for providing an environmentally enhanced experience to a user reading an eBook in proximity to a television. The system includes an eBook reader and a VOD television delivery system in communication with the eBook reader and the television. The eBook reader includes means for sending a page indication to the VOD television delivery system identifying a page of the eBook displayed on the eBook reader. The VOD television delivery system includes means for delivering an audio or video stream to the television in response to receiving the page indication from the eBook reader, the audio or video stream being associated with text or an illustration on the eBook page displayed on the eBook reader.

In another embodiment, the present invention is directed to a method of providing an environmentally enhanced experience to a user reading an eBook on an eBook reader in proximity to a television. The method includes the steps of receiving in a VOD television delivery system, a page indication from the eBook reader identifying a page of the eBook displayed on the eBook reader; and delivering an audio or video stream to the television in response to receiving the page indication from the eBook reader, the audio or video stream being associated with text or an illustration on the eBook page displayed on the eBook reader.

In another embodiment, the invention is directed to an eBook reader. The eBook reader includes a non-transitory memory device for storing an application program comprising computer program instructions; and a processor for executing the application program. Execution of the application program causes the processor to control the eBook reader to perform the steps of establishing a data session with a VOD television delivery system; identifying a page of an eBook currently being displayed on the eBook reader; and sending a page indication to the VOD television delivery system identifying the currently displayed page of the eBook.

The present invention augments the reading/playing of an eBook or book application by providing environmental sights and sounds related to the text of the displayed page of the eBook. Applications that implement the interfaces along with the back end content tools needed to create, propagate, and stream the required video files can add a new dimension to the eBook reading experience.

### BRIEF DESCRIPTION OF THE DRAWINGS

In the following section, the invention will be described with reference to exemplary embodiments illustrated in the figures, in which:

FIG. 1 is a simplified block diagram of a system for creating an eVODBook package for use with the present invention;

FIG. 2 is a simplified block diagram of an exemplary embodiment of the system of the present invention; and

FIG. 3 is a flow chart of an exemplary embodiment of the method of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. Additionally, it should be understood that the invention may be implemented in hardware or in a combination of hardware and software. For example, one or more computers or processors may perform the steps of the method of the present invention when executing computer program instructions stored in one or more program memories.

An eBook reader may be a computing device such as, for example, a PC, smart phone, tablet PC, iPad™, or game console. The eBook reader may communicate with the user's STB using a wired or wireless communication link such as an infrared remote control link or radio link. The eBook reader may also communicate with an eBook server in a VOD augmented eBook system through an IP network such as the Internet. In one exemplary embodiment, an application running on the eBook reader and paired with the VOD system presents a glyph or icon on the screen of the eBook reader. When the user touches or swipes this glyph or icon, the eBook reader sends a session setup command to the VOD system and includes an STB identifier (ID) together with an application ID and/or title or asset information. Upon successful session setup, the application may instruct a video pump within the VOD system to stream to the user's STB (for showing on the user's television), various sections of video using standard stream commands along with Society of Motion Picture and Television Engineers (SMPTE) or Normal Play Time (NPT) timecode information. The timecode information provides known time references for a particular piece of media. Use of such timecode information is well known and need not be further described herein.

In one exemplary embodiment, the parameters for streaming the VOD content correspond with page-definition indicators described within metadata and sent to the VOD system by the application. These parameters may be used to indicate, for example, that an identified media asset should be looped while the current page is displayed. A video may be looped, for example, by sending play commands combined with seek/rewind commands from the application. Further, when the user performs an action within the application such as a page turn, stream-control commands may be sent to the video pump directing the pump to stream specified media content at specified offsets.

One example of a book suitable for use with the present invention is “The Jungle Book” by Rudyard Kipling, for which a corresponding movie was made. When the user launches the book on the eBook reader and touches or swipes the VOD glyph or icon, the application causes a VOD session to be set up and the offering associated with the application is told to stream the first twenty seconds of the corresponding movie and then pause, seek to the beginning, and play again. For example, the television may show the title of the movie along with sound effects such as ambient jungle noise. When the user performs a page turn on the eBook reader, the reader sends an indication to the VOD system, and the video pump is instructed to seek to a designated place within the movie associated with the new page and play for 20 seconds. For example, simply turning to a page on the eBook reader that describes or shows a picture of a lion may cause the VOD system to seek and play on the user's television, a section within the movie where a lion roars.

Other onscreen elements such as images or navigational items may also trigger pump stream-control messages to be sent. For example, there may be a picture of drums on the currently displayed page of the eBook. When the user touches the picture of the drums, the eBook reader sends an indication to the VOD system, and the video pump in the VOD system seeks to a part of the movie where jungle drums can be heard and begins looping in a similar fashion. As the book progresses, various images, video clips, sounds, and/or songs are shown and/or heard on the user's television (and its surround sound system if so equipped) while the user is reading the book.

During normal VOD sessions, a prolonged period of inactivity may cause the VOD system to tear down the session. In order to keep the VOD session from being torn down during an eVODBook session, the application may periodically send “keep alive” messages from the eBook reader to the VOD system to extend the session beyond the normal inactivity period. However, an application termination event such as expiration of a lengthened inactivity timer, turning the last page of the eBook, or turning off the eBook reader may cause the application to send a stream-teardown message to the VOD system, thus ending the session.

At any time, the application user may “disconnect” the VOD streaming from the application. This may be done, for example, by touching or swiping the same VOD glyph or icon used to initiate the session, or by touching or swiping a different glyph or icon. This interaction causes the application to send a stream-teardown message to the VOD system, thus ending the session.

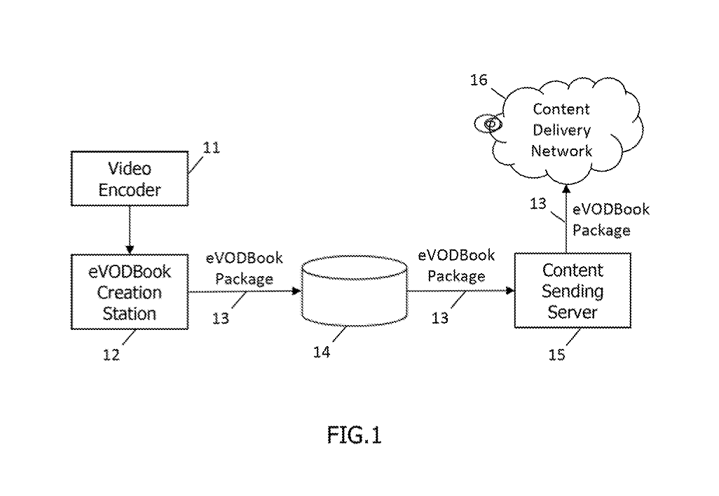

FIG. 1 is a simplified block diagram of a system for creating an eVODBook package for use with the present invention. A video encoder 11 provides encoded video information to an eVODBook creation station 12. The creation station is an interactive station such as a PC that enables a creator to author, edit, and package an eVODBook package 13. The package may be stored in an eVODBook data store 14 prior to being sent to a content sending server 15. A content delivery network 16 then delivers the eVODBook package to various VOD system operators.

The video information may be, for example, a movie that relates to a particular eBook. The movie may be edited to include page identifiers linked to page turn indications received from the eBook reader. The page identifiers may be included in metadata sent in VOD content transmissions. For example a page identifier may be sent in a Trial Use Field, which is an App_Data element with a Name attribute that differs from any other Name attribute in use. Trial Use Fields may be freely included in VOD content transmissions. Table 1 below shows an example of a page identifier:

TABLE 1

| | | | | Required |
|---|---|---|---|---|
| | Metadata | | | vs |
| Spec | Name | Description | Type | Optional |
| MOD | Page | Page Begin and Ending pair, | String (max 128 chars, | Opt |
| or | | with page range location | 1024 total for all headings) | |
| SVOD | | formatted in SMPTE format | containing the two | |
| | | (HH:MM:SS:FF). | components (SMPTE time | |
| | | Numeric Page range in the | code, heading), one per | |
| | | format page#-page#. | element. Ex: | |
| | | The separator shall be a “,” | <App_Data App=”MOD” | |
| | | between the code begin, | Name=”Page” | |
| | | end, and page number | Value=”00:01:01:01,00:02: | |
| | | range. | 19:01,1-1”>. | |

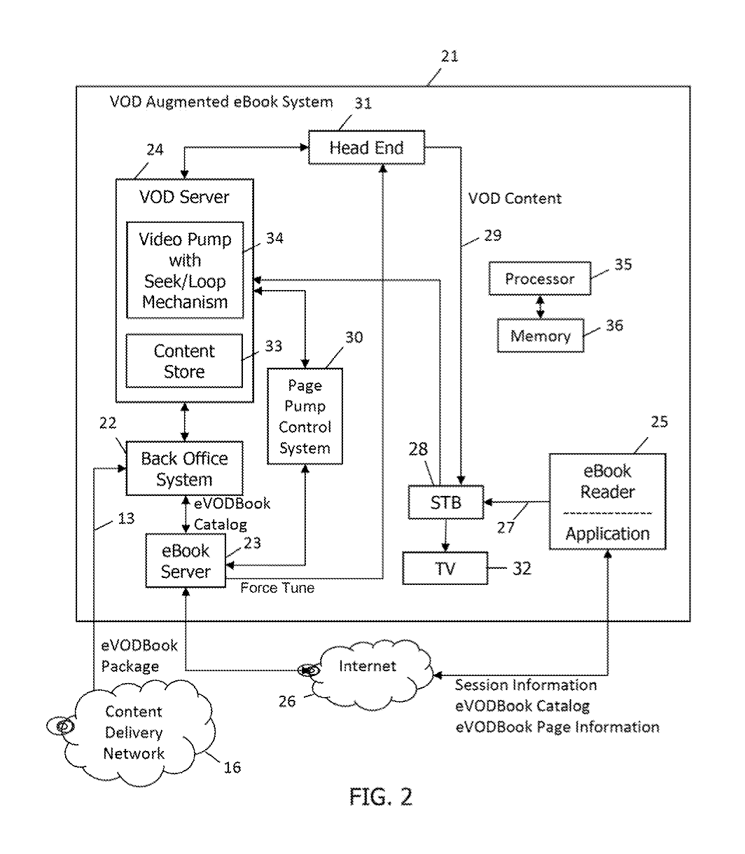

FIG. 2 is a simplified block diagram of an exemplary embodiment of the VOD Augmented eBook system 21 of the present invention. The eVODBook package 13 created in FIG. 1 may be received from the content delivery network 16 in a VOD system operator's back office system 22. The eVODBook package includes eBook page timings associated with eBook VOD content. The back office system may control session setup with an eBook server 23 and a VOD server 24, as well as controlling functions such as content propagation, catalog generation, and billing management. The eBook server 23 communicates with the user's eBook reader 25 via an IP network such as the Internet 26 to exchange session setup and teardown information, eVODBook catalog information, and eVODBook page information for matching with VOD content.

The eBook reader 25 may also communicate through remote control commands 27 with the user's STB 28. The STB communicates with the VOD server 24, and the VOD server sends VOD content 29 to the STB through Head End 31. The STB then delivers the VOD content to the user's television 32. The VOD server may include a content store 33 and a video pump 34 with a seek/loop mechanism that locates the portion of the VOD content that relates to the eBook page information and then loops the VOD content for the required period of time.

The eBook server 23 also communicates with the Head End 31 to send a Force Tune message targeted to the user's STB 28. The Force Tune message causes the STB to tune to the channel where the eVODBook content is transmitted. The eBook server and VOD server 24 also exchange pump control commands through a Page Pump Control System 30 for playing the VOD content related to the eBook page information.

One or more computers or processors 35 may control the functions of the present invention when executing computer program instructions stored in one or more program memories 36. Additionally, individual components of the invention may include their own processor and memory for controlling their functions.

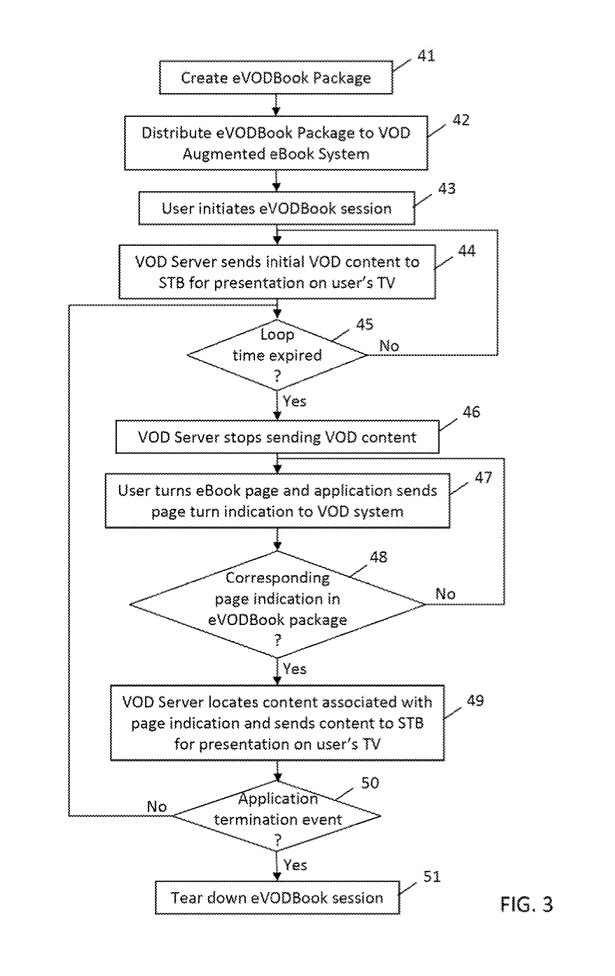

FIG. 3 is a flow chart of an exemplary embodiment of the method of the present invention. At step 41, the eVODBook package 13 is created as shown in FIG. 1. At step 42, the content delivery network 16 distributes the eVODBook package to the VOD Augmented eBook system 21. At step 43, the user initiates an eVODBook session, for example by touching or swiping a VOD glyph or icon on the eBook reader 25 causing the application in the eBook reader to initiate session setup. The setup information includes a user ID or an equipment ID for the user's STB so that the VOD system can identify where to stream the VOD content. At step 44, the Page Pump Control System 30 controls the VOD server 24 to send initial VOD content to the user's STB for presentation on the user's television.

The eVODBook package defines the length of time or number of loops that the VOD content is to be shown. At step 45, it is determined whether the loop time has expired. If not, the method returns to step 44 and continues to loop the VOD content. When the loop time expires, the method moves to step 46 where the VOD server 24 stops sending the VOD content. At step 47, the user subsequently turns an eBook page and the application sends a page turn indication to the VOD system. At step 48, the system determines whether there is a corresponding page indication in the eVODBook package related to additional VOD content to be delivered. If not, the method returns to step 47 and waits for another page turn indication. When there is a corresponding page indication in the eVODBook package, the method moves to step 49 where the VOD server locates the additional VOD content associated with the page indication and sends the additional VOD content to the user's STB for presentation on the user's television.

At step 50, the VOD system determines whether an application termination event has occurred. Events such as expiration of a lengthened inactivity timer, turning the last page of the eBook, touching or swiping the VOD glyph or icon on the eBook reader, or turning off the eBook reader may cause the application to send a stream-teardown message to the VOD system, thus ending the session. If such an event has not occurred, the method continues the session by returning to step 45. When an application termination event occurs, the method moves to step 51 where the eVODBook session is torn down.

To further illustrate the operation of the present invention, two exemplary use cases are described below.

Use Case 1 (Story Read Along):

1) Timmy's parents are subscribers of Communications Cable Company.

2) Communications Cable Company deploys Multiscreen Television applications, which support remotely controlling the VOD pump and force-tuning an STB to a frequency.

3) Communications Cable Company has released the new eVODBook application. This application links video displayed on the television with the pages the user has open in an eBook.

4) Timmy's dad is busy and decides to let Timmy read along with a children's book. Timmy's dad realizes Timmy has been getting behind on his reading and this will be a good educational tool for Timmy. Timmy's dad browses the eVODBook catalog (displayed on an eBook reader) to identify eVODBooks available for rent.

5) Timmy's dad sees “Alice in Wonderland” starring Johnny Depp as the Mad Hatter reading the book.

6) Timmy's dad rents the book on his eBook reader and gives the reader to Timmy.

7) As Timmy turns the pages, the Mad Hatter reads the pages that Timmy is on.

a. The eVODBook application is sending page information to the eBook server.

b. The eBook server sends a start play time to the Page Pump Control System which manages the play and pause times to the VOD pump. The VOD server is sent a play with NPT time. The Page Pump Control System monitors the time current play time. Once the Pause time is reached (i.e., the loop time expires), the Page Pump Control System sends a pause command to the VOD Server.

c. The eBook Server waits until the next page turn indication is received from the eVODBook application on the user's eBook reader.

9) Timmy can turn back pages and the Mad Hatter reads the page(s) that Timmy turned to in the book.

Use Case 2 (Story Environments):

1) Julie loves to read romance novels. Julie found an eVODBook romance novel, which takes place in Brazil.

2) Julie is at a place in her book where the lovers in the book are on a beach in Rio. The audio and visual environments presented through the VOD system are sounds of the ocean. There is also a video of the beach in Rio and the audio is in digital surround sound.

3) The lovers go on an Amazon cruise. The VOD environment changes to sounds of the Amazon as well as the ship's sounds in the background.

4) The lovers end up in the rain forest. Sounds and scenes from the Amazon jungle are displayed through the VOD system.

5) The lovers begin to play in the rain in the Amazon. The Amazon jungle environment changes to a jungle rainforest rain.

The present invention thus augments the reading/playing of an eBook or book application by providing environmental sights and sounds related to the text of the displayed page of the eBook, adding a new dimension to the eBook reading experience.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A system for providing an environmentally enhanced experience to a user reading an electronic book (eBook) in proximity to a television, the system comprising:
an eBook reader; and
a Video On Demand (VOD) television delivery system in communication with the eBook reader and the television;
wherein the eBook reader includes means for sending a page indication to the VOD television delivery system identifying a page of the eBook displayed on the eBook reader; and
wherein the VOD television delivery system includes means for delivering an audio or video stream to the television in response to receiving the page indication from the eBook reader, the audio or video stream being associated with text or an illustration on the eBook page displayed on the eBook reader.

2. The system according to claim 1, wherein the means within the eBook reader for sending the page indication to the VOD television delivery system includes:
an application program comprising computer program instructions stored on a non-transitory memory device;
an interface through an external data network to the VOD television delivery system; and
a processor for executing the application program, wherein execution of the application program causes the processor to control the eBook reader to establish a data session with the VOD television delivery system and to send a different page indication to the VOD television delivery system whenever the user turns to a different page of the eBook.

3. The system according to claim 1, wherein the means within the VOD television delivery system for delivering an audio or video stream to the television includes:
an eVODBook package stored on a non-transitory memory device, the eVODBook package associating the page indication with an associated start and stop time in the video stream;
a processor in a Page Pump Control System for sending start, stop, and loop commands to a video pump in accordance with the eVODBook package;
a cable Head End; and
a VOD server for controlling the Head End to send the audio or video stream from the video pump to a Set Top Box (STB) connected to the television in accordance with the start, stop, and loop commands.

4. The system according to claim 3, wherein the VOD television delivery system also includes means for sending a force tune message to the STB, the force tune message causing the STB to tune to a channel where the audio or video stream is transmitted.

5. The system according to claim 3, further comprising an eVODBook creation station for creating the eVODBook package, said creation station comprising:
an interactive creation program comprising computer program instructions stored on a non-transitory memory device;
a first interface for receiving encoded video content;
a second interface for receiving metadata that includes a plurality of page indications; and
a processor for executing the creation program to create the eVODBook package, wherein the eVODBook package associates each of the plurality of page indications with an associated start and stop time in the video stream.

6. A method of providing an environmentally enhanced experience to a user reading an electronic book (eBook) on an eBook reader in proximity to a television, the method comprising the steps of:
receiving in a Video On Demand (VOD) television delivery system, a page indication from the eBook reader identifying a page of the eBook displayed on the eBook reader; and
delivering an audio or video stream to the television in response to receiving the page indication from the eBook reader, the audio or video stream being associated with text or an illustration on the eBook page displayed on the eBook reader.

7. The method according to claim 6, wherein the step of delivering an audio or video stream to the television includes:
accessing by a processor, an eVODBook package stored on a non-transitory memory device, the eVODBook package associating the page indication with an associated start and stop time in the video stream;
sending start, stop, and loop commands from a Page Pump Control System to a video pump in accordance with the eVODBook package; and
controlling a cable Head End to send the audio or video stream from the video pump to a Set Top Box (STB) connected to the television in accordance with the start, stop, and loop commands.

8. The method according to claim 7, further comprising sending a force tune message from the VOD television delivery system to the STB, the force tune message causing the STB to tune to a channel where the audio or video stream is transmitted.

9. The method according to claim 7, further comprising the steps of:
creating the eVODBook package by an eVODBook creation station, said creating step including:
receiving encoded video content;
receiving metadata that includes a plurality of page indications; and
executing a creation program by a processor to create the eVODBook package, wherein the eVODBook package associates each of the plurality of page indications with an associated start and stop time in the video stream.

10. The method according to claim 6, further comprising the steps of:
accessing by a processor in the eBook reader, an application program comprising computer program instructions stored on a non-transitory memory device in the eBook reader; and
executing the application program by the processor, wherein execution of the application program causes the processor to control the eBook reader to establish a data session with the VOD television delivery system and to send a different page indication to the VOD television delivery system whenever the user turns to a different page of the eBook.

11. The method according to claim 10, further comprising tearing down the data session upon detecting an application termination event selected from:
expiration of an inactivity timer;
detecting that the user turned the last page of the eBook;
detecting that the user touched or swiped a teardown glyph or icon on the eBook reader; and
detecting that the user turned off the eBook reader.

12. An electronic book (eBook) reader, comprising:
a non-transitory memory device for storing an application program comprising computer program instructions; and
a processor for executing the application program, wherein execution of the application program causes the processor to control the eBook reader to perform the steps of:
establishing a data session with a Video On Demand (VOD) television delivery system;
identifying a page of an eBook currently being displayed on the eBook reader; and
sending a page indication to the VOD television delivery system identifying the currently displayed page of the eBook.

13. The eBook reader according to claim 12, wherein the processor also causes the eBook reader to send a different page indication to the VOD television delivery system whenever the user turns to a different page of the eBook.

14. The eBook reader according to claim 12, wherein the processor also causes the eBook reader to send a teardown message to the VOD television delivery system to tear down the data session upon detecting an application termination event selected from:
expiration of an inactivity timer;
detecting that the user turned the last page of the eBook;
detecting that the user touched or swiped a teardown glyph or icon on the eBook reader; and
detecting that the user turned off the eBook reader.
